(19) United States
(12) Patent Application Publication
(10) Pub. No.: US 2026/0186391 A1
(43) Pub. Date: Jul. 2, 2026

(54) THUMB GRIP STRUCTURE AND CAMERA FRAME ACCESSORY

(71) Applicant: TILTA INC., Burbank, CA (US)

(72) Inventors: Shujin FU, Shenzhen (CN); Wenping ZENG, Shenzhen (CN); Kefeng ZHOU, Shenzhen (CN)

(21) Appl. No.: 19/431,665

(22) Filed: Dec. 23, 2025

(30) Foreign Application Priority Data
Dec. 27, 2024 (CN) 202423298406.0
Dec. 27, 2024 (CN) 202423298968.5

(51) Int. Cl. G03B 17/56

(52) U.S. Cl. CPC G03B 17/563; G03B 17/566

(57) ABSTRACT

A thumb grip includes: a connector, designed to be mounted on a top surface of a camera; a handheld part, which features a finger rest position for placing a finger, with the connector extending outward from the top surface of the camera to connect with the handheld part. The connector is positioned on the top surface of the camera and extends directly outward from there to link up with the handheld part. This configuration circumvents the functional areas on the side of the camera screen. Thus, when the thumb grip is installed on the camera, it not only provides a convenient place for finger placement but also avoids structural interference with the functional areas on the side of the camera screen.

### CROSS-REFERENCE TO RELATED APPLICATIONS

The present application for patent claims priority to and the benefit of pending Chinese Application Nos. 202423298968.5 and 202423298406.0, both filed Dec. 27, 2024, and hereby expressly incorporated by reference herein as if fully set forth below in its entirety and for all applicable purposes.

### TECHNICAL FIELD

The present disclosure pertains to the field of camera accessories, specifically to a thumb grip and a camera frame accessory.

### INTRODUCTION

When a camera is in use, to meet users'demands for comfortable handling, a camera thumb grip is frequently installed to provide a resting position for the user's thumb.

However, for certain cameras, functional and control areas such as function buttons are located on the screen side. Installing a camera thumb grip may result in interference between the thumb grip and these functional areas on the camera screen side.

For instance, a camera thumb grip may include a grip body equipped with a clamping block for clamping onto the camera's hot shoe. The right end of the grip body can be bent backward and downward at an angle between 16 and 22 degrees, with a circular arc transition provided at the bend. This camera thumb grip can be conveniently installed and removed by clamping onto the camera's hot shoe. The ergonomic design of the grip body allows the thumb to press precisely on the bent portion when holding the camera, thereby enhancing grip strength. Nevertheless, when functional areas such as function buttons are present on the camera screen side, structural interference may occur between this type of camera thumb grip and the functional areas during installation and use.

### SUMMARY

To address the aforementioned issues, the primary objective of the present disclosure is to provide a thumb grip structure that, when installed on a camera, facilitates finger resting and avoids structural interference with functional areas on the camera screen side.

Another objective of the present disclosure is to provide a camera frame accessory that, when installed on a camera, facilitates finger resting and avoids structural interference with functional areas on the camera screen side.

To achieve these objectives, the technical solution of the present disclosure is as follows.

A thumb grip structure, including:
a connector, configured to be disposed on the top surface of a camera;
a handheld part, provided with a finger rest position for resting a finger, with the connector extending outward from the top surface of the camera to connect with the handheld part.

The beneficial effects of the present disclosure are as follows: In this thumb grip structure, the connector is positioned on the top surface of the camera and extends directly outward to connect with the handheld part, thereby avoiding functional areas on the camera screen side. Consequently, when the thumb grip structure is installed on the camera, it not only facilitates finger resting but also prevents structural interference with the functional areas on the camera screen side.

### BRIEF DESCRIPTION OF THE DRAWINGS

FIG. 1 is a schematic drawing illustrating a camera frame accessory installed on a camera according to some aspects of the disclosure.

FIG. 2 is a schematic drawing illustrating an exploded view of the camera frame accessory and the camera according to some aspects of the disclosure.

FIG. 3 is a schematic drawing illustrating a top plate and a thumb grip from a first perspective according to some aspects of the disclosure.

FIG. 4 is a schematic drawing illustrating the top plate and thumb grip from a second perspective according to some aspects of the disclosure.

FIG. 5 is a schematic drawing illustrating the top plate and thumb grip from a third perspective according to some aspects of the disclosure.

Reference numerals used in drawings:
1. thumb grip structure; 11. connector; 111. first connecting part; 1111. first recess;
112. second connecting part; 1121. second recess; 113. third connecting part; 114. first abutted surface; 12. handheld part; 121. finger rest position; 122. second abutted surface;
123. anti-slip surface; 1231. anti-slip groove;
2. top plate; 21. side fixing part; 211. fixing hole; 212. additional hanging hole; 213. microphone hole; 214, mounting point;
3. camera; 31. functional area; 32. top function button; 33. camera hanging hole; 34. screen; 35. hot shoe interface;
4. hot shoe cover.

### DETAILED DESCRIPTION

In order to more clearly explain the objectives, technical solutions, and aspects of the present disclosure, the disclosure is further described in detail below with reference to the accompanying drawings and exemplary embodiments. It should be understood that the exemplary embodiments are provided solely for illustrative purposes and are not intended to limit the present disclosure.

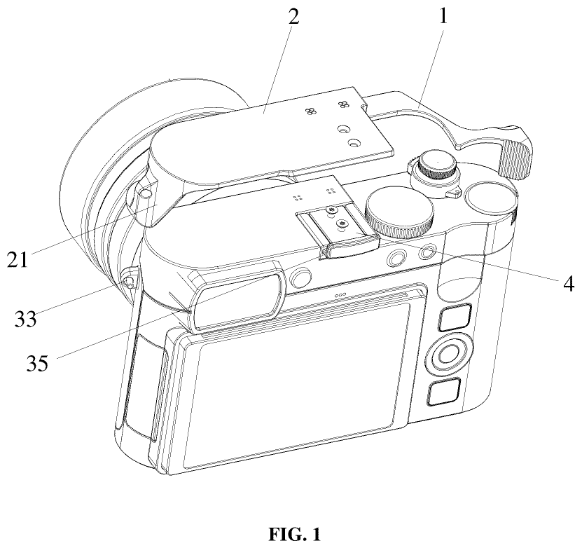

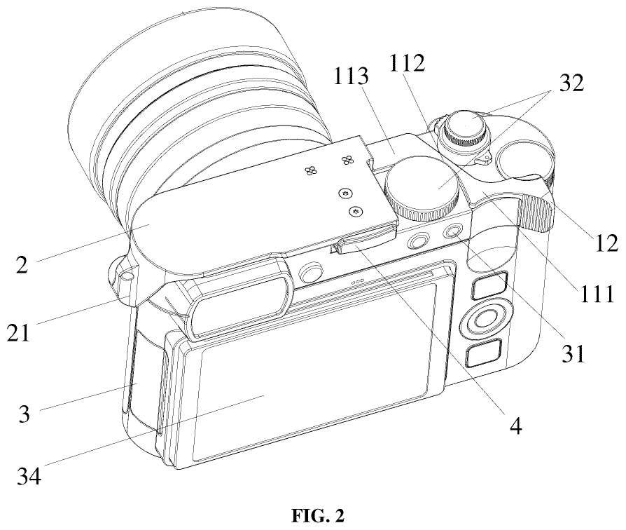

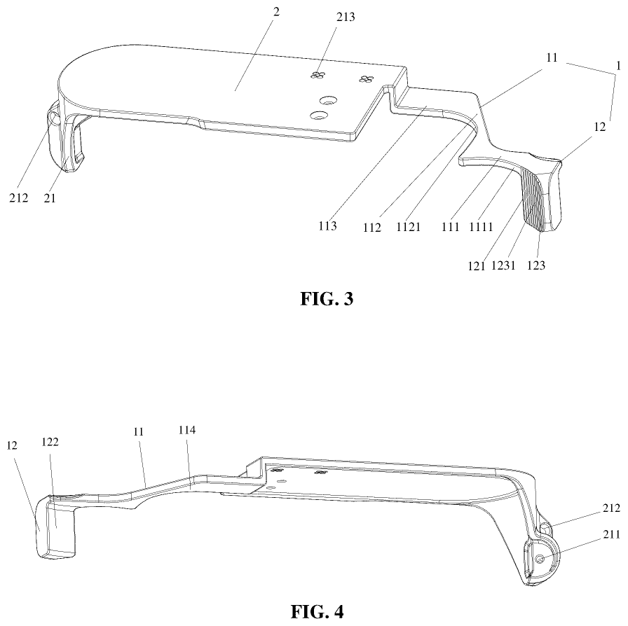

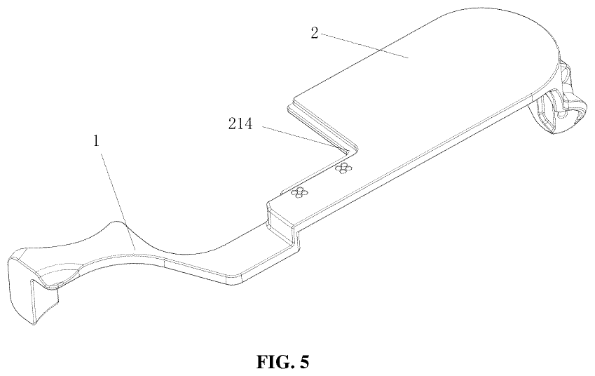

Referring to FIGS. 1-4, aspects of the present disclosure provide a thumb grip 1, including: a connector 11, configured to be disposed on a top surface of a camera 3; a handheld part 12, provided with a finger rest position 121 for resting a finger, with the connector 11 extending outward from the top surface of the camera 3 to connect with the handheld part 12. In some aspects, depending on the type of camera 3 or usage requirements, the connector 11 can extend outward from the top surface of the camera 3 toward a screen 34 side or toward a peripheral side of the camera 3 to connect with the handheld part 12.

In some aspects, when the top plate 2 is installed on the top surface of the camera 3, the connector 11 is simultaneously installed on the top surface of the camera 3 along with the top plate 2. The connector 11 extends directly outward from the top surface of the camera 3 to connect with the handheld part 12, without passing through the functional area 31 on the screen 34 side of the camera 3. Thus, when the thumb grip 1 is installed on the camera 3, it not only facilitates finger resting but also prevents structural interference with the functional area 31 on the screen 34 side of the camera 3.

In some aspects, the connector 11 is configured to pass between or at least partially around the periphery of top function buttons 32 on the top surface of the camera 3.

In some aspects, the connector 11 includes:
a first connecting part 111, located on the side of the top surface of the camera 3 near the screen 34 and connected to the handheld part 12;
a second connecting part 112, configured to pass between or at least partially extend around the periphery of the top function buttons 32 on the top surface of the camera 3, with a distal end of the first connecting part 111 away from the handheld part 12 connected to the second connecting part 112;
a third connecting part 113, installed on the side of the top surface of the camera 3 away from the screen 34, with a distal end of the second connecting part 112 away from the first connecting part 111 connected to the third connecting part 113.

In some aspects, a side of the second connecting part 112 can extend around the periphery of the top function buttons 32, ensuring structural stability of the connector 11 while avoiding the positions of the top function buttons 32 of the camera 3. In some aspects, the first connecting part 111, the second connecting part 112, and the third connecting part 113 are integrally formed.

In some aspects, the side of the first connecting part 111 near the screen 34 of the camera 3 is provided with a first recess 1111 that conforms to the shape of the camera 3. Based on the provision of this first recess 1111, the first connecting part 111 can more closely conform to the shape of the camera 3 and will not protrude from the front side of the camera 3, thereby avoiding any impact on the user experience of the thumb grip 1.

In some aspects, the first recess 1111 connects with the finger rest position 121. When a user's finger rests on the finger rest position 121, the combination of the finger rest position 121, the first recess 1111, and a corresponding recess on the camera 3 expands the range available for finger resting. In some aspects, the first recess 1111 and the finger rest position 121 together form a curved surface, better adapting to ergonomics for the finger.

In some aspects, the second connecting part 112 is provided with a second recess 1121 that conforms to the shape of the top function buttons 32 of the camera 3. When the second connecting part 112 passes through the top function buttons 32 of the camera 3, the second recess 1121 provides clearance for the top function buttons 32 of the camera 3.

In some aspects, the connecting element as a whole is shaped like the numeral “2”.

In some aspects, the connector 11 is provided with a first abutted surface 114 for attaching to the top surface of the camera 3. This first abutted surface 114 is flat, allowing for better attachment to the top surface of the camera 3.

In some aspects, the handheld part 12 is provided with a second abutted surface 122 for attaching to a peripheral side of the camera 3. This second abutted surface 122 is curved, allowing for better attachment to the peripheral side of the camera 3.

In some aspects, an anti-slip surface 123 is provided at the finger rest position 121 to increase friction between the finger rest position 121 and the finger. In one example, the anti-slip surface 123 can have multiple parallel anti-slip grooves 1231.

Referring to FIGS. 1-4, a camera frame accessory, includes: the thumb grip 1; and a top plate 2 for fixing to the top surface of the camera 3, with the thumb grip 1 connected to or separable from the top plate 2. When the thumb grip 1 is connected to the top plate 2, it can include the third connecting part 113 of the thumb grip 1 that is connected to the top plate 2.

In some aspects, the thumb grip 1 and the top plate 2 are integrally formed.

In some aspects, the thumb grip 1 can be directly fixed to the top surface of the camera 3 without a direct connection to the top plate 2. When fixed, it can be secured using screws or adhesive. Alternatively, the thumb grip 1 can be directly fixed to the top plate 2 and installed on the top surface of the camera 3 via the top plate 2.

In some aspects, a side of the top plate 2 away from the handheld part 12 is bent to form a side fixing part 21. The side fixing part 21 is provided with a fixing hole 211 (e.g., slot) for fixing to a camera hanging hole 33 (e.g., attachment hole). In some aspects, the fixing hole 211 and the camera hanging hole 33 can be fixed together using screws.

In some aspects, the frame accessory further includes a hot shoe cover 4 for insertion into a hot shoe interface 35 of the camera 3, with the top plate 2 connected to the hot shoe cover. In some aspects, after inserting the hot shoe cover 4 into the hot shoe interface 35, the top plate 2 is fixed to the hot shoe cover 4 using screws. The provision of the hot shoe cover 4 not only provides dust protection for the hot shoe interface 35 of the camera 3 but also restricts the position of the top plate 2, preventing it from deflection. This design, in conjunction with the fixing hole 211 of the side fixing part 21, allows for more stable installation on the camera 3.

In some aspects, the side fixing part 21 is further provided with an additional hanging hole 212. This additional hanging hole 212 can be used for installing external accessories.

In some aspects, a side of the top plate 2 near the thumb grip 1 is provided with a mounting port 214, inside which a step structure is provided, and the hot shoe cover 4 is correspondingly installed in the mounting port 214.

In some aspects, the top plate 2 is further provided with a microphone hole 213 for providing clearance for a top microphone of the camera 3.

The above descriptions are merely exemplary embodiments of the present disclosure and are not intended to limit the present disclosure. Any modifications, equivalent replacements, and improvements made within the spirit and principles of the present disclosure shall be included within the scope of protection of the present disclosure.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A thumb grip, comprising:
a connector configured to be disposed on a top surface of a camera; and
a handheld part provided with a finger rest position for resting a finger, wherein the connector extends outward from the top surface of the camera to connect with the handheld part.

2. The thumb grip according to claim 1, wherein the connector is further configured to pass between function buttons on the top surface of the camera.

3. The thumb grip according to claim 2, wherein the connector is further configured to circumvent, at least partially, peripheries of the function buttons.

4. The thumb grip according to claim 1, wherein the connector comprises:
a first connecting part located on a side of the top surface of the camera proximate to a screen of the camera, wherein the first connecting part is connected to the handheld part;
a second connecting part configured to pass between function buttons on the top surface of the camera or at least partially extend around peripheries of the function buttons,
wherein an end of the first connecting part distal from the handheld part is connected to the second connecting part; and
a third connecting part mounted on a side of the top surface of the camera distal from the screen of the camera, wherein an end of the second connecting part distal from the first connecting part is connected to the third connecting part.

5. The thumb grip according to claim 4, wherein the first connecting part, the second connecting part, and the third connecting part are integrally formed as a single piece.

6. The thumb grip according to claim 4, wherein a first recess conforming to a shape of the camera is provided on a side of the first connecting part, and the side is proximate to the screen of the camera.

7. The thumb grip according to claim 6, wherein the first recess adjoins the finger rest position, and the first recess and the finger rest position together form a curved surface.

8. The thumb grip according to claim 4, wherein the second connecting part is provided with a second recess conforming to a shape of the function buttons on the top surface of the camera.

9. The thumb grip according to claim 1, wherein the connector is provided with a first abutted surface for adhering to the top surface of the camera; and
wherein the handheld part is provided with a second abutted surface for adhering to a peripheral side of the camera.

10. The thumb grip according to claim 1, wherein the connector is provided with a first abutted surface for adhering to the top surface of the camera.

11. The thumb grip according to claim 1, wherein the handheld part is provided with a second abutted surface for adhering to a peripheral side of the camera.

12. The thumb grip according to claim 1, wherein the finger rest position is provided with an anti-slip surface, and the anti-slip surface is provided with multiple anti-slip grooves.

13. A camera frame accessory, comprising:
the thumb grip according to claim 1; and
a top plate for fixing to the top surface of the camera, wherein the thumb grip is connected to the top plate.

14. The camera frame accessory according to claim 13, wherein the thumb grip is detachably connected to the top plate.

15. The camera frame accessory according to claim 13, wherein the thumb grip and the top plate are integrally formed as a single piece.

16. The camera frame accessory according to claim 13, wherein a side of the top plate distal from the handheld part is bent to form a side fixing part, and the side fixing part is provided with a fixing hole for fixing to a camera hanging hole.

17. The camera frame accessory according to claim 13, wherein the camera frame accessory further comprises a hot shoe cover configured to be inserted into a hot shoe interface of the camera, and the top plate is connected to the hot shoe cover.

18. The camera frame accessory according to claim 13, wherein the top plate is provided with a mounting port proximate to the thumb grip.
